(19) United States
(12) Patent Application Publication
(10) Pub. No.: US 2014/0361616 A1
(43) Pub. Date: Dec. 11, 2014

(54) SYSTEM WITH TWO-STAGE OUTPUT VOLTAGE

(71) Applicant: ASIAN POWER DEVICES INC., Taoyuan County (TW)

(72) Inventor: Chen-En LEE, Taoyuan County (TW)

(21) Appl. No.: 14/298,250

(22) Filed: Jun. 6, 2014

(30) Foreign Application Priority Data
Jun. 10, 2013 (TW) 102120640

(51) Int. Cl. H02J 4/00

(52) U.S. Cl. CPC H02J 4/00
USPC 307/23

(57) ABSTRACT

A system with two-stage output voltage includes an external power source unit, a dying gasp control circuit unit, and a power source storage unit. The dying gasp control circuit unit is connected to the external power source unit via signals to monitor whether an output power outputted from the external power source unit is interrupted or not. The power source storage unit is connected to the external power source unit and the dying gasp control circuit unit via signals. The output power outputted from the external power source unit is initially stored in the power source storage unit, and an output voltage outputted from the power source storage unit is controlled by the dying gasp control circuit unit. When the output voltage is changed to a predetermined voltage, the system is notified to execute a dying gasp operation.

### BACKGROUND

1. Technical Field

The present disclosure relates generally to a design of a power circuit, and more particularly to a system with two-stage output voltage.

2. Description of Related Art

The rapidly increased Internet information demands promote the development and population of the broadband access service. Because it is advantageous in the deployment convenience and price performance ratio of the digital subscriber line (DSL) technology, the DSL technology is continuously developed and has become the principal broadband access technology all over the world.

Asymmetric digital subscriber line (ADSL) is the most common type of DSL. The ADSL customer premise equipment (CPE) are configured, monitored, maintained, and upgraded according to conditions of the central office equipment (COE). According to the International Telecommunications Union (ITU) standard G992.1, the ADSL CPE has to generate dying gasp signals, and transmit the dying gasp signals to the ADSL COE through an embedded operation channel (EOC) when the ADSL CPE runs out of power so that the network administrator correctly judges the ADSL network failures.

Once the ADSL CPE is not supplied power, however, the drying gasp signal cannot be transmitted from the ADSL CPE to the digital subscriber line access multiplexer (DSLAM). Therefore, the ADSL CPE has to be supplied power from other power sources, such as a super capacitor or a capacitor circuit which is composed of a plurality of super capacitors so as to transmit the drying gasp signals. When the ADSL CPE normally operates, the capacitor circuit is charged by an input voltage Vin through a dying gasp control circuit unit. On the contrary, the capacitor circuit supplies power to maintain the input voltage Vin to providing power for a certain time when the ADSL CPE runs out of power. At the same time, the ADSL CPE transmits the drying gasp signals to the DSLAM. Furthermore, the capacitor circuit is only supplied power to the specific processor without other electronic components in order to reduce power consumption and extend the time of executing the dying gasp operation.

The dying gasp operation is executed when the input voltage is reduced below a predetermined voltage value so that the necessary operations are processed, such as a data storage operation. Once the input voltage is reduced, however, the maintained time is limited and even the necessary operations cannot be completed in the maintained time.

### SUMMARY

Accordingly, an object of the present disclosure is to provide a system with two-stage output voltage to control an output voltage outputted from a power source storage unit by monitoring an output power outputted from an external power source unit. The output voltage is reduced to be a voltage value to produce a dying gasp signal so as to extend the time of supplying power from the power source storage unit and effectively lengthen the executable time of processing necessary operations.

In order to achieve the above-mentioned or other objects, the system with two-stage output voltage includes an external power source unit, a dying gasp control circuit unit, and a power source storage unit. The dying gasp control circuit unit is connected to the external power source unit via signals to monitor whether an output power outputted from the external power source unit is interrupted or not. The power source storage unit is connected to the external power source unit and the dying gasp control circuit unit via signals. The output power outputted from the external power source unit is initially stored in the power source storage unit, and an output voltage outputted from the power source storage unit is controlled by the dying gasp control circuit unit.

Accordingly, the dying gasp control circuit unit controls the power source storage unit to output a first predetermined voltage when the external power source unit continuously supplies power; the dying gasp control circuit unit controls the power source storage unit to output a second predetermined voltage when the external power source unit stops supplying power; wherein the first predetermined voltage is greater than the second predetermined voltage. Once the output voltage of the power source storage unit 120 is changed from the first predetermined voltage to the second predetermined voltage, the system is notified to execute a dying gasp operation. The output voltage is reduced to be a voltage value to produce a dying gasp signal so as to extend the time of supplying power from the power source storage unit and effectively lengthen the executable time of processing necessary operations.

It is to be understood that both the foregoing general description and the following detailed description are exemplary, and are intended to provide further explanation of the present disclosure as claimed. Other advantages and features of the present disclosure will be apparent from the following description, drawing and claims.

### BRIEF DESCRIPTION OF DRAWING

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawing, in which:

FIG. 1 is a schematic view of a system with two-stage output voltage according to the present disclosure.

### DETAILED DESCRIPTION

Reference will now be made to the drawing figures to describe the present invention in detail.

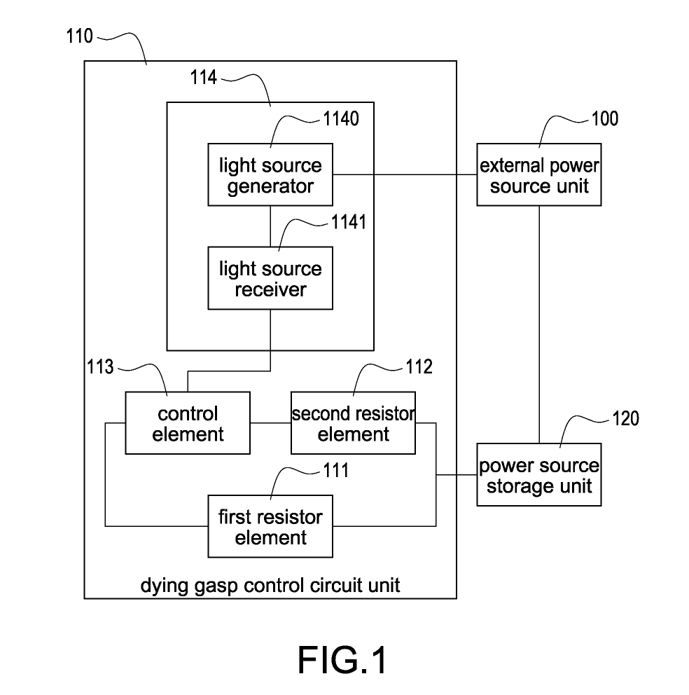

Reference is made to FIG. 1 which is a schematic view of a system with two-stage output voltage according to the present disclosure. The system includes an external power source unit 100, a dying gasp control circuit unit 110, and a power source storage unit 120. The dying gasp control circuit unit 110 has a first resistor element 111, a second resistor element 112, a control element 113, and a monitoring element 114.

The external power source unit 100 is used to provide the required power to the whole system. The required power is stored in the power source storage unit 120, and then the stored power is outputted from the power source storage unit 120. In particular, the power source storage unit 120 can be a capacitor, a power converter, or other equivalent elements or devices.

The dying gasp control circuit unit 110 is connected to the external power source unit 100 and the power source storage unit 120 via signals. The dying gasp control circuit unit 110 controls the output voltage outputted from the power source storage unit 120 by monitoring whether the output power outputted from the external power source unit 100 is interrupted or not.

As mentioned above, the dying gasp control circuit unit 110 has the first resistor element 111, the second resistor element 112, the control element 113, and the monitoring element 114. The second resistor element 112 is connected in series to the control element 113, and then is connected in parallel to the first resistor element 111. The monitoring element 114 is connected to the control element 113 by signals. The control element 113 can be a MOSFET or other equivalent elements. The monitoring element 114 has a light source generator 1140 and a light source receiver 1141. The light source generator 1140 is connected to the external power source unit 100 via signals and the light source receiver 1141 is connected to the control element 113 via signals.

When the external power source unit 100 continuously supplies power, the light source generator 1140 is excited to produce light and the produced light can be transmitted to the light source receiver 1141. When the light source receiver 1141 receives the light transmitted from the light source generator 1140, the light source receiver 1141 is turned on (or is in an on-state condition). Also, the control element 113 is turned on and the first resistor element 111 is connected in parallel to the second resistor element 112 to provide a new resistance value so that the power source storage unit 120 outputs a first predetermined voltage, such as a 12-volt voltage.

On the contrary, the light source generator 1140 does not produce light when the external power source unit 100 stops supplying power, thus turning off the light source receiver 1141. Also, the control element 113 is turned off so that the second resistor element 112 is invalid. In this condition, the first resistor element 111 is only valid so that the power source storage unit 120 outputs a second predetermined voltage, such as a 9-volt voltage. In particular, the first predetermined voltage is greater than the second predetermined voltage. Once the output voltage of the power source storage unit 120 is changed from the first predetermined voltage to the second predetermined voltage, the system is notified to execute a dying gasp operation.

In brief, the output voltage outputted from the power source storage unit 120 is changed or adjusted according to the output power outputted from the external power source unit 100. The output voltage is reduced to extend the time of supplying power from the power source storage unit 120 when the output power outputted from the external power source unit 100 is interrupted. Accordingly, the time of executing the dying gasp operation can be effectively lengthened to increase the executable time of processing necessary operations, such as a data storage operation. Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A system with two-stage output voltage, comprising:
an external power source unit;
a dying gasp control circuit unit connected to the external power source unit via signals and configured to monitor whether an output power outputted from the external power source unit being interrupted; and
a power source storage unit connected to the external power source unit and the dying gasp control circuit unit via signals; the output power outputted from the external power source unit being initially stored in the power source storage unit, and an output voltage outputted from the power source storage unit being controlled by the dying gasp control circuit unit;
wherein the dying gasp control circuit unit is configured to control the power source storage unit outputting a first predetermined voltage when the external power source unit continuously supplies power; the dying gasp control circuit unit is configured to control the power source storage unit outputting a second predetermined voltage when the external power source unit stops supplying power; wherein the first predetermined voltage is greater than the second predetermined voltage.

2. The system with two-stage output voltage in claim 1, wherein the dying gasp control circuit unit comprises a first resistor element, a second resistor element, a control element, and a monitoring element;
the second resistor element is connected in series to the control element, and then is connected in parallel to the first resistor element; the monitoring element is connected to the control element via signals; the monitoring element is configured to turn on the control element when the monitoring element monitors that the external power source unit continuously supplies power, so that the first resistor element is connected in parallel to the second resistor element to provide a new resistance value to make the power source storage unit output the first predetermined voltage; the monitoring element is configured to turn off the control element when the monitoring element monitors that the external power source unit stops supplying power, so that the first resistor element is provided to make the power source storage unit output the second predetermined voltage.

3. The system with two-stage output voltage in claim 2, wherein the monitoring element has a light source generator and a light source receiver; the light source generator is connected to the external power source unit via signals, and the light source receiver is connected to the control element via signals.

4. The system with two-stage output voltage in claim 3, wherein the control element is a MOSFET.

5. The system with two-stage output voltage in claim 4, wherein the power source storage unit is a capacitor.

6. The system with two-stage output voltage in claim 4, wherein the power source storage unit is a power converter.
